(19) United States
(12) Patent Application Publication
(10) Pub. No.: US 2018/0285172 A1
(43) Pub. Date: Oct. 4, 2018

(54) DATA EXCHANGE BETWEEN APPLICATIONS

(71) Applicant: VMware, Inc., Palo Alto, CA (US)

(72) Inventors: Stephen Turner, Atlanta, GA (US); Sandeep Naga Kaipu, Atlanta, GA (US); Dipanshu Gupta, Atlanta, GA (US)

(21) Appl. No.: 15/470,984

(22) Filed: Mar. 28, 2017

(51) Int. Cl. G06F 9/54; G06F 9/445; G06F 21/62

(52) U.S. Cl. CPC G06F 9/546; G06F 21/62; G06F 9/44521

(57) ABSTRACT

Disclosed are various examples for exchanging data between applications installed on a mobile device. An app-to-app messaging protocol is provided that an application developer can leverage to exchange information with other applications without the application developer needing to fully implement the protocol.

### BACKGROUND

Applications installed on a mobile device may have a need to communicate amongst one another. In an enterprise environment, information technology (IT) administrators often require enrollment of a mobile device with a management service as a managed device. Enrollment of the mobile device can initiate an exchange of information with a server environment, such as authentication credentials, tokens, encryption keys, or other data that facilitates enrollment and management of the device. It might be desirable to exchange information received from a server with other applications installed on the mobile device. However, certain operating system environments, such as the ANDROID operating system, might not, in certain versions, provide a secure mechanism for applications to exchange data between one another. In some examples, application-to-application messaging or communication protocols or application programming interfaces (APIs) might be cumbersome to implement for an application developer.

An application-to-application messaging protocol can be used by applications that are deployed by a management service or that otherwise establish trust with one another for the purpose of exchanging data. For example, in a single sign-on scenario, an authentication key or token might be acquired by one application after the application or user authenticates itself with a single sign-on service. Accordingly, the application can then share the key or token with other applications that might also require the token.

In prior solutions, an application-to-application messaging protocol might require the applications to use a messaging framework provided by the operating system or a secure storage area secured by the operating system in which data can be stored. Utilizing an operating system messaging protocol can be a cumbersome process. Additionally, some operating systems fail to provide a secure storage area where data such as authentication tokens, encryption keys, or other sensitive data can be securely stored and exchanged between applications.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing of a networked environment according to various examples of the disclosure.

FIGS. 2-4 depict a sequence diagram illustrating an example component interaction according to various examples of the present disclosure.

FIG. 5 is a flowchart illustrating an example of functionality according to various examples of the present disclosure.

### DETAILED DESCRIPTION

The present disclosure relates to providing an application-to-application messaging protocol. The application-to-application messaging protocol can allow applications that implement the protocol or incorporate a software development kit (SDK) library that implements the protocol to securely exchange data between applications that are installed on a computing device. The application-to-application messaging protocol can allow a device that is enrolled as a managed device with a management service to obtain an application whitelist that identifies whitelisted or trusted applications with which data can be shared using the application-to-application messaging protocol.

Additionally, a channel map can specify which applications are subscribed to a particular communications channel that can be created and supported on a computing device. The channel map can also allow an application to enter or leave a communications channel as needed or as the application is updated by an application developer. The application-to-application messaging protocol can allow applications to exchange data among one another without needing to implement a cumbersome inter-process communication framework. Additionally, the application-to-application messaging protocol can allow for secure exchange of potentially sensitive data between applications on platforms that might not provide secure communications or secure storage mechanisms. For example, in certain versions of the ANDROID operating system environment, a secure key storage area is not provided. In contrast, other versions of the operating system, or other operating systems, such as IOS, provide a secure key storage area, which is sometimes referred to as a KEYCHAIN.

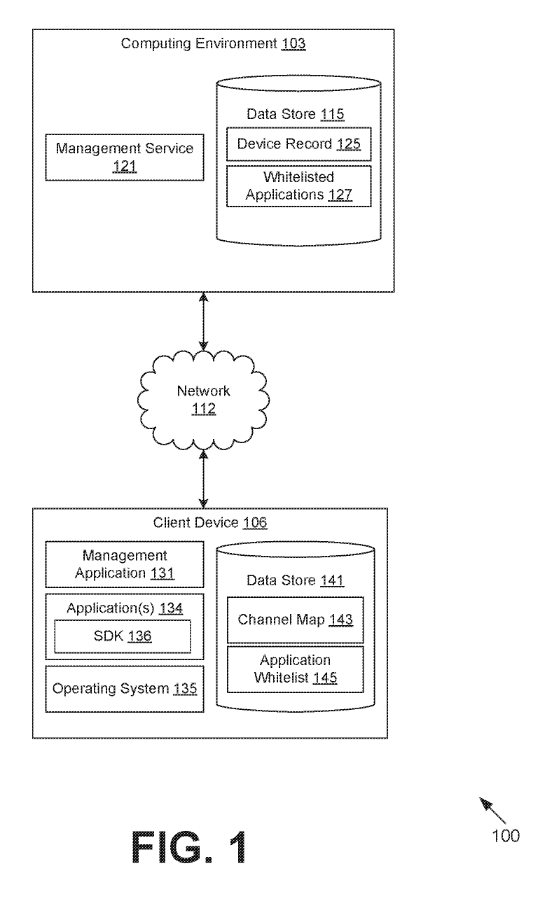

With reference to FIG. 1, shown is a networked environment 100 according to various examples. The networked environment 100 includes a computing environment 103 and a client device 106 which can be in data communication with one another over the network 112. The network 112 includes, for example, the Internet, one or more intranets, extranets, wide area networks (WANs), local area networks (LANs), wired networks, wireless networks, other suitable networks, or any combination of two or more such networks. For example, the networks can include satellite networks, cable networks, Ethernet networks, and other types of networks.

The computing environment 103 can include, for example, a server computer or any other system providing computing capabilities. Alternatively, the computing environment 103 can employ multiple computing devices that can be arranged, for example, in one or more server banks, computer banks, or other arrangements. The computing devices can be located in a single installation or can be distributed among many different geographical locations. For example, the computing environment 103 can include multiple computing devices that together form a hosted computing resource, a grid computing resource, or any other distributed computing arrangement. In some cases, the computing environment 103 can operate as at least a portion of an elastic computing resource where the allotted capacity of processing, network, storage, or other computing-related resources can vary over time. The computing environment 103 can also include or be operated as one or more virtualized computer instances. Generally, the computing environment 103 can be operated in accordance with particular security protocols such that they are considered trusted computing environments.

The computing environment 103 can execute a management service 121, which can manage or oversee the operation of multiple client devices 103. In some examples, an enterprise, such as one or more companies or other organizations, can operate the management service 121 to oversee or manage the operation of the client devices 106 of employees, contractors, or other users within an enterprise environment. In this sense, the client devices 103 can include managed devices that are managed by the management service 121.

To facilitate management of client devices 103, the management service 121 can establish a secure communications session or mechanism with the client devices 103 (e.g., a mobile device management channel, or MDM channel). The management service 121 can establish the secure communications mechanism by creating a secure communication link with the client device 106. A secure communication link can be established using MDM application programming interfaces (APIs) that are provided by an operating system executed by the client device 106. In some examples, the secure communications mechanism can be established using a push notifications framework or notification service provided by an operating system ecosystem associated with the client device 106 that allows for communications between the management service 121 and a client device 106 over the network 212 that are encrypted using a digital certificate.

The client device 106 can be enrolled as a managed device with the management service 121 through APIs provided by the operating system. The enrollment process can include authentication of a user's credentials. Upon authentication of a user's credentials by the management service 121, the client device 106, using the MDM APIs of the operating system, can enroll the client device 106 as a managed device so that various management functions can be securely performed over the secure communications channel.

Examples of management functions can include commands to erase certain data from the client device 106, commands to install certain applications or application updates, commands to lock a client device 106 or activate a display lock feature, a command to remotely perform a factory reset of the client device 106, or other management functions. Additionally, data can be securely transmitted through the secure communications channel to the client device 106 or to applications executed by the client device 106.

Additionally, the operating system of the client device 106 can also provide the ability to create access-restricted storage that is associated with particular applications installed on the client device 106. Access-restricted storage can be associated with multiple applications that are installed on the client device 106 through the secure communications mechanism. In some scenarios, applications that are signed by a common certificate can be provided access to the access-restricted storage of each other, whereas applications that are not signed by the certificate do not have access to the access-restricted storage of other applications. Additionally, the management service 121 can transmit data to the client device 106 over the secure communications channel that can be stored in the access-restricted storage such that it is accessible by certain applications and inaccessible to other applications that are installed on the client device 106.

The secure communications mechanism can be encrypted or secured using a digital certificate that is associated with the client device 106, the management service 121, or an enterprise with which the client device 106 is associated. In one scenario, the management service 121 can obtain a security certificate that is unique to a particular enterprise with which a client device 106 is associated. In one example, an administrator associated with the enterprise can provide a certificate to the management service 121 using an administrator console or other functionality with which a certificate can be uploaded. The certificate can also be signed by a certificate authority, which can in some cases be operated by the management service 121. The management service 121 can encrypt or secure the secure communications channel using the certificate so that the secure communications channel is a secure communication link over the network 112 through which data can be sent to the client device 106.

Additionally, the management service 121 can specify that data sent through the secure communications mechanism can only be accessed by certain applications installed on the client device 106. The applications that can access data sent through the secure communications mechanism can also be restricted in how certain data can be manipulated, viewed or handled on the client device 106. For example, an application installed on the client device 106 can be coded to restrict the ability of a user to capture, share, or otherwise remove data from the client device 106 that is received through the secure communications channel.

The management service 121 can also facilitate ensuring that client devices 106 that are administered by the management service 121 are operating in compliance with various compliance rules. In one scenario, the management service 121 can issue management commands that instruct a client device 106 to take a particular action with respect to a compliance rule. For example, if a client device 106 is designated as lost or stolen, the management service 121 can issue a command instructing the client device 106 to erase data and applications that were previously sent to the client device 106 through the secure communications channel or other communication links and otherwise stored on the client device 106. The management service 121 can also obtain data from a third party computing environment, such as an application, a security code, authentication token, or other data. As another example, if the management service 121 determines that a client device 106 has violated a compliance rule with respect to having unauthorized modifications or unauthorized applications installed on the client device 106, the management service 121 can issue a command instructing the client device 106 to erase data and applications stored on the client device 106. As a further example, the management service 121 can also issue a command instructing the client device 106 to activate a display lock of the client device 106 that requires a user to enter a personal identification number (PIN) in order to use the client device 106.

To issue a command to a client device 106, the identity provider 206 can establish a command queue for a particular client device 106. The management application 131 installed on the client device 106 can periodically retrieve commands from the command queue and execute them on the client device 106. In other implementations, commands can be pushed to a client device 106 through an operating system API that provides devices with management capability to management service 121.

The data stored in the data store 115 and available to the management service 121 includes, for example, device records 125, whitelisted applications 127, and potentially other data. For example, the data store 115 can also include authentication data associated with users or application developers, SDK keys issued to applications, and other data. In one example, authentication data can include data used to verify one or more security credentials presented by a user for authentication.

A device record 125 can include information about a particular client device 106 that is enrolled with the management service 121 as a managed device. A device record 125 can include various security settings selected for enforcement on a client device 106 that is enrolled with the management service 121. Accordingly, a device record 125 can include a device identifier associated with a device, such as the client device 106, one or more device certificates, a compliance status, and other data. In some examples, a device record 125 can also identify a user associated with a particular client device 106. The compliance status can indicate whether a particular client device 106 is in compliance with one or more compliance rules.

More specifically, the device record 125 can include one or more of: data describing the identity, type and components of the client device 106; data describing the state of the client device 106; data describing organizational groups to which the client device 106 belongs; data describing compliance rules 135 with which the client device 106 must comply; data describing management policies that specify if, when, and how the client device 106 is permitted to function; and data describing a command queue associated with the client device 106.

For example, data describing the identity, type and components of the client device 106 can specify at least one of more of: a unique identifier associated with the client device 106 (e.g., identifier issued by a manufacturer of the client device or the management service 121), a device type of the client device (e.g., a smartphone, a tablet computing, a laptop computer, a desktop computer, a server computer, or a virtualized instance of any of such computer types), and various software and hardware components of the client device 106 (e.g., operating system [or kernel or bios] type and version, processor type and speed, memory type and size, network interface types, various I/O component types such as camera, touchscreen, keyboard, mouse, printer). More particularly, a device record 125 associated with a client device 106 comprising a network connection television can specify that the client device 106 type is a phone, that the client device 106 has an active connection to the Internet, and that the client device 106 has a camera enabled.

Next, data describing the state of the client device 106 can specify, for instance, various settings that are applied to the client device 106, various applications that are installed on or being executed by the client device 106, and various files that are installed on or are accessible to the client device 106. Additionally, the data describing the state of the client device 106 can specify information related to the management of the client device 106, such as the last time the client device 106 provided its state information to the management service 121, whether the client device 106 is in a state of compliance with any applicable compliance rules 135, and whether any remedial actions have been (or are to be) taken as a result of a noncompliance with any applicable compliance rules. Also being related to the management of the client device 106, the data describing organizational groups to which the client device 106 belongs can, for example, include any organizational groups of which the client device 106 is a member (by virtue of a static hard coded relationship between the client device 106 and an organizational group, or by virtue of a dynamic evaluation of a membership condition associated with an organizational group, as described later herein).

Further, the device record 125 can include data describing a command queue associated with the client device 106. For example, the management service 121 can maintain a command queue of commands that are designated for execution against the client device 106. As described herein, a client device 106 can be provisioned by the management service 121 by causing resources to be installed or stored on the client device 106. To implement such process, the management service 121 can store a command related to provisioning in the command queue. Additionally, the management service 121 can store a command related to a remedial action associated with a compliance rule in the command queue in the event that it is determined that a rule condition associated with the compliance rule has occurred. Whether a provisioning command or a command related to a remedial action is stored in the command queue, the client device 106 can retrieve commands stored in its command queue through various ways that are described later herein (e.g., through a client-server “pull system” or through a client-server “push system”).

Within the context of a management service 121 that manages the operating of enrolled client devices 106, compliance rules can include one or more rules that, when violated, can cause the management service 121 to issue a management command. Compliance rules can include a list of unauthorized hardware functions, software functions, or applications that potentially pose a threat to enterprise data or to the use of enterprise applications. As noted above, if client device 106 falls out of compliance with one or more compliance rules, a management command can be transmitted to the client device 106 instructing the client device 106 to perform one or more actions specified by the compliance rule. Alternatively, a compliance rule can also reside on the client device 106, which can self-enforce compliance rules.

The data store 115 can also include information about whitelisted applications 127. Whitelisted applications 127 represent applications that are authorized by the management service 121 or an IT administrator to use the application-to-application messaging protocol to share information among applications on the client device 106. Whitelisted applications 127 can include a list of applications and identifying information about the applications, such as a bundle identifier, application identifier, application signature, a developer signature, or other information that can uniquely identify an application with respect to other applications. As will be described herein, the management service 121 can deploy an application whitelist to an enrolled client device 106 that identifies applications that are trusted or permitted to use the application-to-application messaging protocol.

In some examples, the data store 115 can also store one or more channel maps that can identify various communication channels that can be created within the application-to-application messaging protocol on a client device 106. A channel map created by an administrator can identify default communication channels that exist on a client device 106 enrolled with the management service 121. The channel map can also, in some cases, identify particular applications from the application whitelist that should be subscribed to or associated with a particular communication channel on a client device 106. In some examples, the channel map can be deployed by the management service 121 to a client device 106 upon enrollment of the client device 106 as a managed device.

The client device 106 can represent a processor-based system, such as a computer system, that can be embodied in the form of a desktop computer, a laptop computer, a personal digital assistant, a cellular telephone, a smartphone, a set-top box, a music player, a web pad, a tablet computer system, a game console, an electronic book reader, or any other device with like capability. The client device 106 can include a display that includes, for example, one or more devices such as liquid crystal display (LCD) displays or other types of display devices. The client device 106 can also be equipped with networking capability or networking interfaces, including a localized networking or communication capability such as an NFC capability, RFID read and/or write capability, a microphone and/or speaker, or other localized communication capability.

The client device 106 can execute various applications, such as a management application 131 and other applications 134, such as an email client, games, productivity applications, messaging applications, or other applications that might be deployed to the client device 106 by the management service 121 or installed on the client device 106 by a user. Certain applications 134 can incorporate a software development kit library, or SDK 136. The SDK 136 can include a set of management or security functionalities that an application developer can leverage without needing to author their own code providing certain functionality. For example, the SDK 136 can include encryption methods that can provide data security functions that an application developer can leverage. As another example, the SDK 136 can include a single sign-on library so that an application developer can leverage the user authentication capabilities of a single sign-on service without needing to author their own code that communicates with the service.

Accordingly, the SDK can also include one or more library, class, or methods that implement the application-to-application messaging protocol so that an application developer of an application 134 can incorporate the application-to-application messaging protocol into an application 134 without needing to author their own code that implements the protocol. The application-to-application messaging protocol is discussed in more detail in the discussion that follows.

The operating system 135 of the client device 106 can provide management APIs that the management application 131 can utilize to help manage the client device 106 as a managed device with the management service 121. Although described as an application, it is understood that the management application 131 can be an integral component of an operating system 135 of the client device 106. The operating system 135 can also provide an inter-process communication framework atop of which the application-to-application messaging protocol can be implemented.

The data store 141 of the client device 106 can include mass storage or persistent memory resources of the client device 106. The data store 141 can be managed by the operating system 135 and accessible to applications 134 that are installed on the client device 106. In some examples, the data store 141 can include storage areas that are private or specific to certain applications 134 installed on the client device 106. In other examples, the data store 141 can include storage areas that are accessible by all applications 134. In some cases, storage areas of the data store 141 can be accessible only to certain applications 134 that are signed with a particular developer identifier or developer signature.

The data in the data store 141 can include a channel map 143 and an application whitelist 143. In some examples, each application 134 that implements the application-to-application messaging protocol can store and/or maintain its own copy of the channel map 143 and application whitelist 145. The channel map 143 can identify the various communication channels that exist for applications 134 to communicate with one another using the application-to-application messaging protocol. For example, a single sign-on channel can be registered or created and allow applications 134 to exchange authentication tokens or keys related to a single sign-on service with which one or more of the applications 134 or the management application 131 has authenticated. As another example, an encryption keys channel can be created that allows applications 134 to exchange encryption keys that can be used for data security or encryption purposes.

In some cases, the channel map 143 can be obtained by the management application 131 from the management service 121. In one scenario, a default channel map 143 can be obtained from the management service 121. In some implementations, the management application 131 or applications 134 having the SDK 136 or an implementation of the application-to-application messaging protocol can create or register their own communication channels for data exchange between applications 134.

The application whitelist 145 can identify applications 134 that are permitted to exchange data using the application-to-application messaging protocol on the client device 106. The application whitelist 145 can be a signature-based whitelist. The signature of an application 134 can be verified on the device with a signature obtained by the management application 131 or applications 134 having the SDK 136 from the management service or an application repository from which the application was obtained. In some examples, checksums can be computed on an application signature, certificate, the application binary, or a portion of the application binary on the device and compared against a checksum computed on the same data on the application from an authoritative source. An application 134 that sends data using the application-to-application messaging protocol can be verified by an application 134 that receives the data against the application whitelist 145 so that unauthorized applications 134 are not permitted to communicate using the application-to-application messaging protocol.

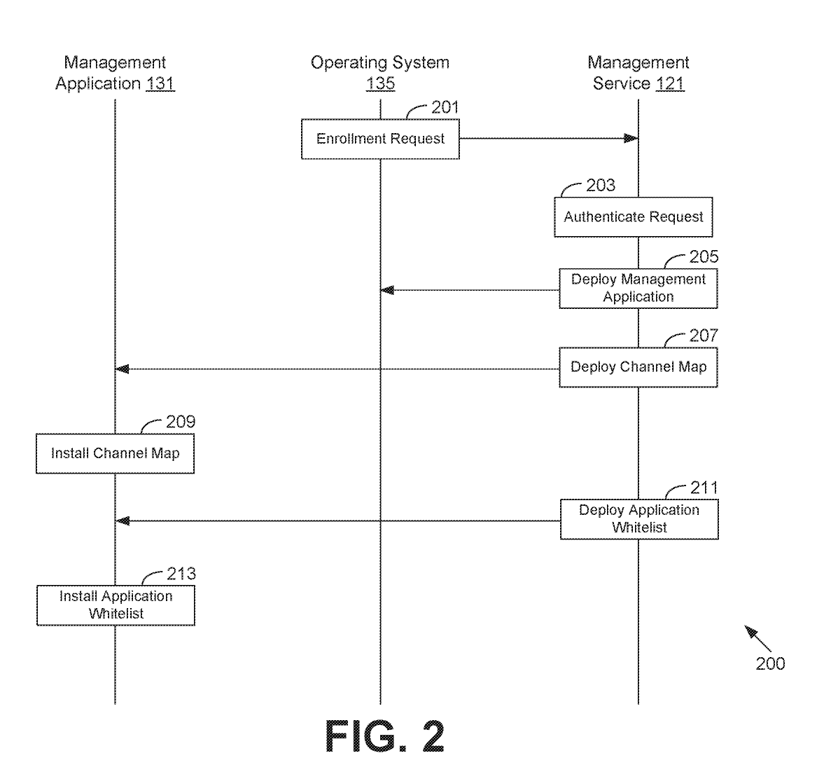

Turning now to FIG. 2, shown is a sequence diagram 200 illustrating one example of interaction between the management application 131, the management service, and the operating system 135. Functionality attributed to the management application 131, the management service, and the operating system 135 can be implemented in a single process or application or in multiple processes or applications. The separation or segmentation of functionality as discussed herein is presented for illustrative purposes only.

Beginning with step 201, the operating system 135 sends an enrollment request to the management service 121. In some examples, the enrollment request can be generated after a user enters his or her credentials within a user interface on the client device 106 that is associated with enrollment of the client device 106 as a managed device with the management service 121. The enrollment request can also be generated by the operating system 135 when the user enters a user identifier for his or her user account, such as an email address, and submits the user identifier within the user interface. The operating system 135 can generate the enrollment request consistent with a management API or management library within the operating system 135.

At step 203, the management service 121 can authenticate the enrollment request. In one example, the management service 121 can communicate with a directory service associated with a user's enterprise to authenticate the request. In another example, the management service 121 can federate the authentication of the request to a directory service or an authentication service to which user authentication is federated. The management service 121 can also enroll the client device 106 as a managed device and create a device record 125 that corresponds to the client device 106 within the data store 112.

At step 205, the management service 121 can deploy the management application 131 to the client device 106. In one scenario, the management service 121 can issue a command to the operating system 135 or an application on the client device 106 that can retrieve and install the management application 131 from an application repository or electronic marketplace. The management application 131 can be installed on the client device 106 with sufficient privileges to assert management authority over certain aspects of the client device 106. In one example, the management application 131 can utilize management APIs provided by the operating system 135 to perform the various management and policy enforcement that is described above.

Next, at step 207, the management service 121 can deploy the channel map 143 to the management application 131. The channel map 143 can identify the default communication channels that applications 134 implementing the application-to-application messaging protocol can utilize to communicate and/or share data on the client device 106. In some examples, the channel map 143 can be managed by the management application 131 on the client device 106. In other examples, the channel map 143 can be distributed by the management application 131 to other applications 134 installed on the client device 106, which can in turn store a copy of the channel map 143 in the data store 112.

At step 209, the management application 131 can install the channel map 143 on the client device 106. In one example, the channel map 143 can be installed on the client device 106 by storing the channel map 143 in the data store 112 and broadcasting a message to the applications 134 implementing the application-to-application messaging protocol that includes the channel map 143 or a notification that the channel map 143 has been installed.

At step 211, the management service 121 can deploy the application whitelist 145 to the management application 131. The application whitelist 145 can identify the applications 134 that are permitted to utilize the application-to-application messaging protocol on the client device 106. In some examples, the application whitelist 145 can be managed by the management application 131 on the client device 106. In other examples, the application whitelist 145 can be distributed by the management application 131 to other applications 134 installed on the client device 106, which can in turn store a copy of the application whitelist 145 in the data store 112.

At step 213, the management application 131 can install the application whitelist 145 on the client device 106. In one example, the application whitelist 145 can be installed on the client device 106 by storing the application whitelist 145 in the data store 112 and broadcasting a message to the applications 134 implementing the application-to-application messaging protocol that includes the channel map 143 or a notification that the application whitelist 145 has been installed.

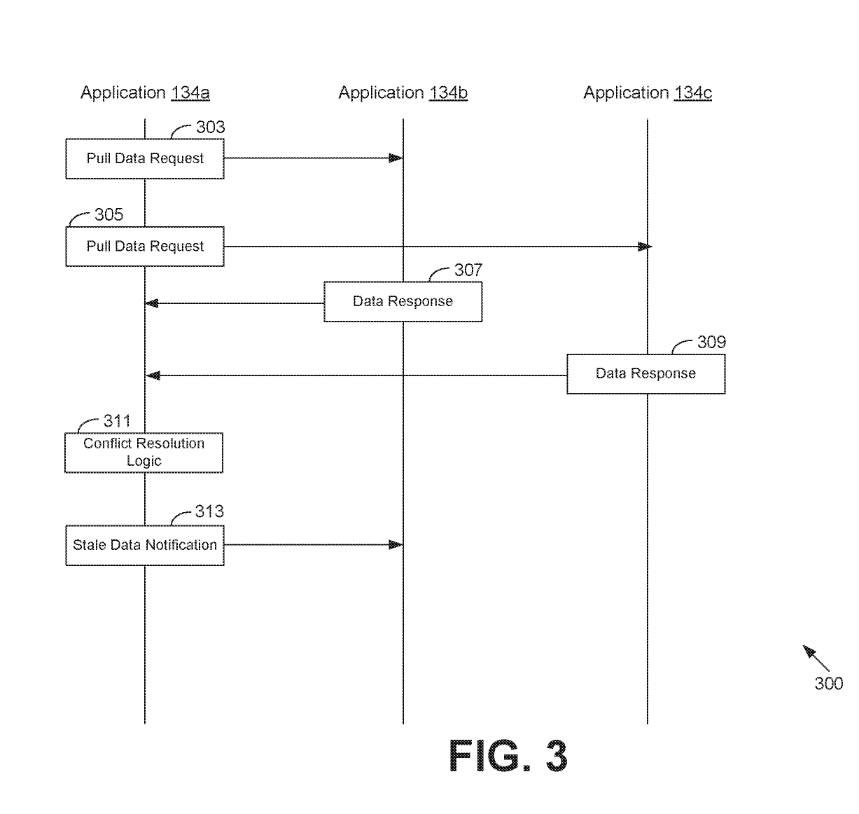

Turning now to FIG. 3, shown is a sequence diagram 300 illustrating one example of interaction between the one or more applications 134a, 134b, and 134c that implement the application-to-application messaging protocol to share data among one another. The example of FIG. 3 shows a scenario in which the application 134a broadcasts a requests for a particular piece of data from other applications 134b and 134c that also implement the application-to-application messaging protocol. In other words, the application 134a broadcasts a request to pull data from the other applications 134b, 134c that are installed on the client device 106 and that implement the application-to-application messaging protocol. The application 134b, 134c can respond to the request to pull a particular piece of data by sending a data response to the application 134a.

Accordingly, at steps 303 and 305, the application 134a can transmit a request to pull data from the application 134b and 134c. The request can be associated with a particular communication channel defined by the channel map 143. In one example, the request can be tagged with an identifier for a particular channel. The request can be sent to the applications 134b and 134c using an inter-process communication protocol associated with the operating system 135. In one example, the pull data request can be sent to a receiving application using an intents framework provided by the operating system 135.

In one scenario, the application 134a can generate a binder service that can run as a background service within the operating system 135 and through which the receiving application 134b and 134c can provide a response to the pull data request. For example, the application 134a can create binder service and provide information about the binder service to the receiving applications 134b and 134c. The applications 134b and 134c can in turn provide a response to the pull data request through the binder service. Upon receiving a response from all of the applications 134 installed on the client device 106 or upon a timeout, the application 134a can destroy or take down the binder service.

At steps 307 and 309, in response to receiving the pull data request from the application 134a, the applications 134b and 134c can provide a data response to the requesting application 134a. The data response can also be tagged or associated with a channel identifier associated with the communication channel on which the pull data requests were sent. The data responses can be provided to the application 134a through a binder service created by the application 134a for the purpose of receiving data from other applications 134 implementing the application-to-application messaging protocol. In one scenario, the data response can be formatted according to a data format specified by the application-to-application messaging protocol. For example, the data response can include metadata that includes a timestamp, an application identifier associated with the sending application, a data type for the data included within the response, and an indication of the communication channel associated with the data response. The data response can also include a data payload. As some examples of data payloads, the data response can include an encryption key, authentication token, textual data, or any other type of data that might be exchanged by applications 134 installed on the client device 106.

At step 311, the application 134a can execute conflict resolution logic on the received data responses to determine which response is a valid data response. The developer of application 134a can implement its own conflict resolution logic that determines how the application 134a can determine which data response it should deem to be valid. In some implementations, the SDK 137 can include one or more virtual methods that may have default implementations but that the application developer can also override. The virtual methods can include a method that determines whether a received data response is newer than or is valid over other data responses that are received. Again, the application developer of an application 134 can override such a virtual method and provide its own conflict resolution logic that the application 134 can execute to select a data response.

At step 313, the application 134a can respond to the received data responses with a stale data notification to the responding application 134b that provided a data response that the conflict resolution logic deems to be stale or invalid data. For example, if, based upon a timestamp of the received data, a particular data response is selected over other data responses as the data response having the most current, up-to-date, or otherwise valid data, the stale data notification can inform the application 134b providing stale data of that fact. In one example, the stale data notification can include the data payload from the other application 134c that provided the valid data. In one scenario, the application 134b can then replace or merge the data payload with its own data received from the application 134a in the stale data notification.

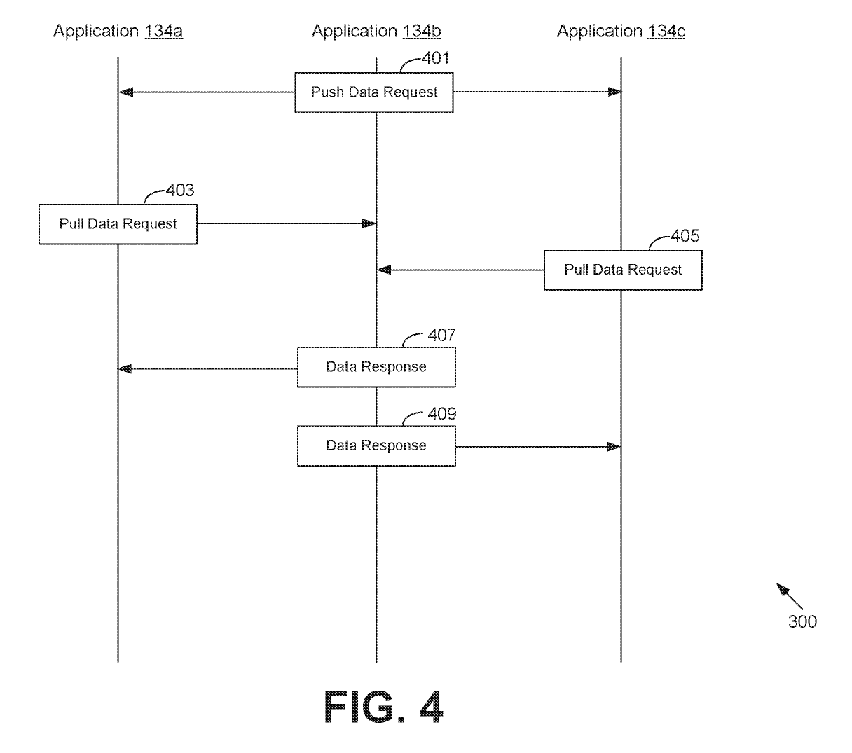

Turning now to FIG. 4, shown is a sequence diagram 400 illustrating one example of interaction between the one or more applications 134a, 134b, and 134c that implement the application-to-application messaging protocol to share data among one another. The example of FIG. 4 shows a scenario in which the application 134b can push data to other applications 134 on the client device 106 using the application-to-application messaging protocol. To implement a push of data to other applications 134 using the application-to-application messaging protocol, the application 134b can transmit a push data request to the other applications 134a, 134c, which causes the other applications 134a, 134c to initiate a pull data request following the flow shown in FIG. 3. For example, the application 134b might require to push data to the other applications 134 subscribed to a particular communication channel to provide an updated authentication token, encryption key, or any other type of data.

Accordingly, at step 401, the application 134b can determine which applications are registered or subscribe to the channel on which the data push will occur by identifying the applications 134 on the channel map 143. Then, the application 134b can transmit a push data request to the applications 134a and 134c subscribed to the communication channel. At steps 403 and 405, the applications 134a and 134c can transmit a request to pull data from the application 134b on the communication channel. Again, the request can be associated with a particular communication channel defined by the channel map 143. In one example, the request can be tagged with an identifier for a particular channel. The push data requests and pull data requests can be sent to the applications 134 using an inter-process communication protocol associated with the operating system 135. In one example, the requests can be sent to a receiving application using an intents framework provided by the operating system 135.

At steps 407 and 409, in response to receiving the pull data request from the application 134a and 134c, the applications 134b can provide a data response to the requesting applications 134a and 134c. The data response can also be tagged or associated with a channel identifier associated with the communication channel on which the pull data requests were sent. The data responses can be provided to the applications 134a, 134c through a binder service created by the applications 134a, 134c for the purpose of receiving data from other applications 134 implementing the application-to-application messaging protocol. In one scenario, the data response can be formatted according to a data format specified by the application-to-application messaging protocol. For example, the data response can include metadata that includes a timestamp, an application identifier associated with the sending application, a data type for the data included within the response, and an indication of the communication channel associated with the data response. The data response can also include a data payload. As some examples of data payloads, the data response can include an encryption key, authentication token, textual data, or any other type of data that might be exchanged by applications 134 installed on the client device 106.

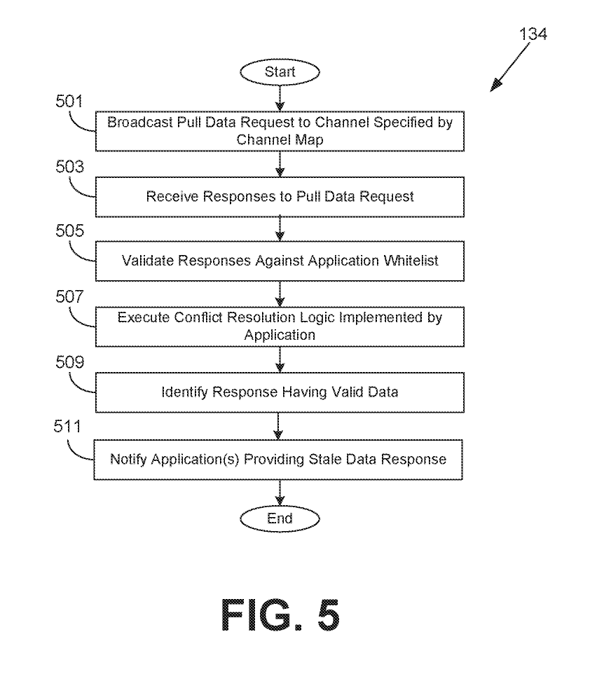

Moving on to FIG. 5, shown is a flowchart that provides one example of the operation of an application 134 implementing the application-to-application messaging protocol. As an alternative, the flowchart of FIG. 5 can be viewed as depicting an example of elements of a method implemented in a computing device. Functionality attributed to the application 134 can be implemented in a single process or application or in multiple processes or applications. Functionality attributed to the application 134 can also be implemented in an SDK 137 library that the application developer can rely upon to implement the application-to-application messaging protocol.

Beginning with step 501, the application 134 can broadcast a request to pull data, or a pull data request to a particular communication channel on which the application is instrumented to obtain data. The pull data request can be tagged with or otherwise associated with a communication channel identifier. The channel identifier can be specified by the channel map 143. In one implementation, the pull data request can be sent to applications that are identified by the channel map 143 as subscribers to the communication channel. For example, if the application 134 requires an encryption key or an authentication token, the application 134 can send request the key or token from the channel that is designated as the communication channel for that purpose.

In one implementation, the application 134 issuing the pull data requests can also create a binder service through an API provided by the operating system 135. The binder service API can allow the application 134 to establish a service through which other applications 134 can transmit data to the application 134 issuing the pull data requests.

At step 503, the application 134 can then receive responses to the pull data request. The data responses can include or be tagged with an identifier associated with the communication channel. The data responses can also include a data payload and metadata. The metadata can include a timestamp and identifying information about the sending application. In one implementation, the data response can be received through the binder service created by the application 134 for the purpose of receiving data from other applications 134 implementing the application-to-application messaging protocol.

At step 505, the application 134 can validate the data responses against the application whitelist 141. The application whitelist 141 can identify applications 134 that are permitted to communicate with other applications 134 using the application-to-application messaging protocol. If a response is received from an application 134 that is not identified by the application whitelist 141, the application 134 receiving the response can ignore the data response. The applications can be identified on the application whitelist 141 by including the bundle identifier or another application identifier within the application whitelist 141.

At step 507, the application 134 can execute conflict resolution logic on the received data responses to determine which response is a valid data response. The developer of application 134 can implement its own conflict resolution logic that determines how the application 134 can determine which data response it should deem to be valid.

At step 509, upon execution of the conflict resolution logic, the application 134 can determine which data response is valid from among the received data responses. In some implementations, the SDK 137 can include one or more virtual methods that may have default implementations but that the application developer can also override. The virtual methods can include a method that determines whether a received data response is newer than or is valid over other data responses that are received. Again, the application developer of an application 134 can override such a virtual method and provide its own conflict resolution logic that the application 134 can execute to select a data response.

At step 511, the application 134 can respond to the received data responses with a stale data notification to the responding applications 134 that provided a data response that the conflict resolution logic deems to be stale or invalid data. For example, if, based upon a timestamp of the received data, a particular data response is selected over other data responses as the data response having the most current, up-to-date, or otherwise valid data, the stale data notification can inform the application 134 providing stale data of that fact. In one example, the stale data notification can include the data payload from the other application 134 that provided the valid data. In one scenario, the application 134 receiving the stale data notification can then replace or merge the data payload with its own data received from the application 134 in the stale data notification.

The flowcharts and sequence diagrams of FIGS. 2-5 show examples of the functionality and operation of implementations of components described herein. The components described herein can be embodied in hardware, software, or a combination of hardware and software. If embodied in software, each element can represent a module of code or a portion of code that includes program instructions to implement the specified logical function(s). The program instructions can be embodied in the form of, for example, source code that includes human-readable statements written in a programming language or machine code that includes machine instructions recognizable by a suitable execution system, such as a processor in a computer system or other system. If embodied in hardware, each element can represent a circuit or a number of interconnected circuits that implement the specified logical function(s).

Although the flowcharts and sequence diagram show a specific order of execution, it is understood that the order of execution can differ from that which is shown. For example, the order of execution of two or more elements can be switched relative to the order shown. Also, two or more elements shown in succession can be executed concurrently or with partial concurrence. Further, in some examples, one or more of the elements shown in the flowcharts can be skipped or omitted.

The client device 106, the management service 121, application 134, or other components described herein can include at least one processing circuit. Such a processing circuit can include, for example, one or more processors and one or more storage devices that are coupled to a local interface. The local interface can include, for example, a data bus with an accompanying address/control bus or any other suitable bus structure.

The one or more storage devices for a processing circuit can store data or components that are executable by the one or more processors of the processing circuit. For example, the management service 121, application 134, and/or other components can be stored in one or more storage devices and be executable by one or more processors. Also, a data store, such as the data store 115 can be stored in the one or more storage devices.

The management service 121, application 134, and/or other components described herein can be embodied in the form of hardware, as software components that are executable by hardware, or as a combination of software and hardware. If embodied as hardware, the components described herein can be implemented as a circuit or state machine that employs any suitable hardware technology. The hardware technology can include, for example, one or more microprocessors, discrete logic circuits having logic gates for implementing various logic functions upon an application of one or more data signals, application specific integrated circuits (ASICs) having appropriate logic gates, programmable logic devices (e.g., field-programmable gate array (FPGAs), and complex programmable logic devices (CPLDs)).

Also, one or more or more of the components described herein that include software or program instructions can be embodied in any non-transitory computer-readable medium for use by or in connection with an instruction execution system such as, a processor in a computer system or other system. The computer-readable medium can contain, store, and/or maintain the software or program instructions for use by or in connection with the instruction execution system.

A computer-readable medium can include a physical media, such as, magnetic, optical, semiconductor, and/or other suitable media. Examples of a suitable computer-readable media include, but are not limited to, solid-state drives, magnetic drives, or flash memory. Further, any logic or component described herein can be implemented and structured in a variety of ways. For example, one or more components described can be implemented as modules or components of a single application. Further, one or more components described herein can be executed in one computing device or by using multiple computing devices.

It is emphasized that the above-described examples of the present disclosure are merely examples of implementations to set forth for a clear understanding of the principles of the disclosure. Many variations and modifications can be made to the above-described examples without departing substantially from the spirit and principles of the disclosure. All such modifications and variations are intended to be included herein within the scope of this disclosure.

Therefore, the following is claimed:

1. A non-transitory computer-readable medium embodying a program executable in a mobile device, the program, when executed by the mobile device, being configured to cause the mobile device to at least:
receive an application whitelist associated with an application-to-application messaging protocol, the application whitelist identifying a plurality of applications that are authorized to communicate with the program using the application-to-application messaging protocol;
receive a channel map associated with the application-to-application messaging protocol, the channel map identifying a plurality of communication channels associated with the application-to-application messaging protocol;
generate a request to receive data through one of the communication channels from at least one other application identified by the application whitelist, the request transmitted through an operating system application programming interface (API) providing data exchange between applications;
receive the data through the operating system API from the at least one other application; and
validate the data received through the operating system API.

2. The non-transitory computer-readable medium of claim 1, wherein the program comprises a software development kit (SDK) library embedded within the application, wherein the SDK library implements the application-to-application messaging protocol.

3. The non-transitory computer-readable medium of claim 2, wherein the SDK comprises an API providing a resolution virtual method, the conflict resolution virtual method defining default conflict resolution logic that validates the data received through the operating system API.

4. The non-transitory computer-readable medium of claim 2, wherein an application defines custom conflict resolution logic that overrides the default conflict resolution logic that validates the data received through the operating system API.

5. The non-transitory computer-readable medium of claim 1, wherein the program generates the request to receive the data through the one of the communication channels through a binder service created by the at least one other application, the binder service created through the operating system API.

6. The non-transitory computer-readable medium of claim 5, wherein the binder service is created as a background service that the application can connect and receive the data associated with the one of the communication channels.

7. The non-transitory computer-readable medium of claim 1, wherein the application whitelist comprises a signature based whitelist comprising an application signature corresponding to each of the plurality of applications.

8. The non-transitory computer-readable medium of claim 1, wherein the program generates another request to push data to other applications registered to the one of the communication channels, the request to push data comprising a request broadcasted to other applications identified by the application whitelist to generate a request to receive data through the one of the communication channels.

9. A system, comprising:
at least one computing device; and
an application executable by the at least one computing device, the application configured to cause the at least one computing device to at least:
receive an application whitelist associated with an application-to-application messaging protocol, the application whitelist identifying a plurality of applications that are authorized to communicate with the program using the application-to-application messaging protocol;
receive a channel map associated with the application-to-application messaging protocol, the channel map identifying a plurality of communication channels associated with the application-to-application messaging protocol;
generate a request to receive data through one of the communication channels from at least one other application identified by the application whitelist, the request transmitted through an operating system application programming interface (API) providing data exchange between applications;
receive the data through the operating system API from the at least one other application; and
validate the data received through the operating system API.

10. The system of claim 9, wherein the application comprises a software development kit (SDK) library embedded within the application, wherein the SDK library implements the application-to-application messaging protocol.

11. The system of claim 10, wherein the SDK comprises an API providing a resolution virtual method, the conflict resolution virtual method defining default conflict resolution logic that validates the data received through the operating system API.

12. The system of claim 11, wherein the application defines custom conflict resolution logic that overrides the default conflict resolution logic that validates the data received through the operating system API.

13. The system of claim 9, wherein the application generates the request to receive the data through the one of the communication channels through a binder service created by the at least one other application, the binder service created through the operating system API.

14. The system of claim 13, wherein the binder service is created as a background service that the application can connect and receive the data associated with the one of the communication channels.

15. The system of claim 9, wherein the application whitelist comprises a signature based whitelist comprising an application signature corresponding to each of the plurality of applications.

16. A method, comprising:
receiving an application whitelist associated with an application-to-application messaging protocol, the application whitelist identifying a plurality of applications that are authorized to communicate with the program using the application-to-application messaging protocol;
receiving a channel map associated with the application-to-application messaging protocol, the channel map identifying a plurality of communication channels associated with the application-to-application messaging protocol;
generating a request to receive data through one of the communication channels from at least one other application identified by the application whitelist, the request transmitted through an operating system application programming interface (API) providing data exchange between applications;
receiving the data through the operating system API from the at least one other application; and
validating the data received through the operating system API.

17. The method of claim 16, wherein the method is implemented in a software development kit (SDK) library embedded within an application, wherein the SDK library implements the application-to-application messaging protocol.

18. The method of claim 17, wherein the SDK comprises an API providing a resolution virtual method, the conflict resolution virtual method defining default conflict resolution logic that validates the data received through the operating system API.

19. The method of claim 17, wherein the application defines custom conflict resolution logic that overrides the default conflict resolution logic that validates the data received through the operating system API.

20. The method of claim 16, further comprising generating the request to receive the data through the one of the communication channels through a binder service created by the at least one other application, the binder service created through the operating system API.
